(19) United States
(12) Patent Application Publication
(10) Pub. No.: US 2023/0271196 A1
(43) Pub. Date: Aug. 31, 2023

(54) Fluidized-Bed Flotation Unit, Mineral Processing Apparatus, and Fluidized-Bed Flotation Method

(71) Applicant: Metso Outotec Finland Oy, Tampere (FI)

(72) Inventor: Ian Sherrell, Tampere (FI)

(73) Assignee: Metso Outotec Finland Oy, Tampere (FI)

(21) Appl. No.: 18/013,102

(22) PCT Filed: Jun. 23, 2021
(86) PCT No.: PCT/FI2021/050484

§ 371 Date: Dec. 27, 2022

Related U.S. Application Data
(60) Provisional application No. 63/046,009, filed on Jun. 30, 2020.

(51) Int. Cl. B03D 1/24; B03D 1/14; B03B 7/00; B03D 1/08

(52) U.S. Cl. CPC B03D 1/24; B03D 1/1456; B03B 7/00; B03D 1/145; B03D 1/085; B03D 1/16

(57) ABSTRACT

A fluidized-bed flotation unit, its use, a mineral processing apparatus, and a fluidized-bed flotation method are disclosed. The fluidized-bed flotation unit includes a tank for holding a volume of slurry. The tank includes a launder with a launder lip, a fine slurry outlet below the launder lip, and a coarse slurry outlet below the fine slurry outlet for discharging coarse output slurry from the volume of slurry. The fluidized-bed flotation unit includes a solid-liquid separation arrangement configured to collect output slurry from the volume of slurry via the fine slurry outlet and to separate suspended solids and flotation liquid from the output slurry to form a solids portion and a liquid portion.

### FIELD OF TECHNOLOGY

This disclosure concerns mineral processing. In particular, this disclosure concerns separation of minerals from their ores by flotation.

### BACKGROUND

The energy consumption of comminution processes, especially grinding, typically constitutes a significant part of overall energy consumption in mineral processing. As such, significant effort has been invested in reducing energy consumption of grinding. This may generally be achieved by lowering the degree of liberation of ore, i.e., by increasing the average size of ore particles prior to concentration. Standard mechanical flotation units are best suited for separation of particles within a size range of approximately 20 μm to 150 μm. Consequently, alternative solutions are required to increase the average particle size of ore beyond 150 μm.

One approach for increasing the recovery of coarser particles is commonly known as fluidized-bed flotation. However, usage of conventional fluidized-bed flotation units may increase water consumption in mineral processing. In light of this, it may be desirable to develop new solutions related to separation of coarser particles.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

According to a first aspect, a fluidized-bed flotation unit is provided. The fluidized-bed flotation unit comprises a tank for holding a volume of slurry, the tank comprising a launder with a launder lip, a fine slurry outlet below the launder lip, and a coarse slurry outlet below the fine slurry outlet for discharging coarse output slurry from the volume of slurry. The fluidized-bed flotation unit further comprises a solid-liquid separation arrangement configured to collect output slurry from the volume of slurry via the fine slurry outlet and to separate suspended solids and flotation liquid from the output slurry to form a solids portion and a liquid portion.

Throughout this specification, “flotation” may refer to separation of a mixture by adhering a substance in said mixture at an interface. In flotation, separation of a mixture may be based on differences in the hydrophobicity of substances in said mixture. Herein, “separation” may refer to the extraction or removal of a substance from a mixture for use or rejection.

Further, “slurry” may refer to a dispersion, comprising solid particles suspended in a continuous phase of flotation liquid. As such, a “volume of slurry” may refer to a certain amount of slurry. In flotation, slurry may be commonly referred to as coarse slurry or as fine slurry depending on its properties.

Herein, “coarse slurry” may refer to slurry, comprising solid particles of larger diameters. As known to the skilled person, the definition of coarse slurry may be application-specific and/or ore-specific. For example, in some embodiments, coarse slurry may refer to slurry, having a particle-size distribution with a percent passing less than 80% at a sieve size of 425 μm, or at a sieve size of 355 μm, or at a sieve size of 250 μm, or at a sieve size of 180 μm, or at a sieve size of 150 μm, or at a sieve size of 125 μm, or at a sieve size of 105 μm.

On the other hand, “fine slurry” may refer to slurry, comprising solid particles of smaller diameters. As known to the skilled person, the definition of fine slurry may be application-specific and/or ore-specific. For example, in some embodiments, fine slurry may refer to slurry, having a particle-size distribution with a percent passing greater than or equal to 80% at a sieve size of 425 μm, or at a sieve size of 355 μm, or at a sieve size of 250 μm, or at a sieve size of 180 μm, or at a sieve size of 150 μm, or at a sieve size of 125 μm, or at a sieve size of 105 μm.

Throughout this disclosure, a “fluidized bed” may refer to a solid-fluid mixture, which exhibits fluid-like properties. As known to the skilled person, a fluidized bed may be maintained by passing pressurized fluid(s), i.e., liquid(s) and/or gas(es), through a particulate medium. Consequently, “fluidized-bed flotation” may refer to flotation, wherein a fluidized bed is maintained in a volume of slurry by suitably passing flotation liquid and/or flotation gas through said volume of slurry.

The term “flotation gas” may refer to any gaseous substance suitable for use in flotation. Although in practical applications air is often used a flotation gas, other types of gaseous substances may also be utilized, as known to the skilled person.

On the other hand, “flotation liquid” may refer to any liquid substance or mixture suitable for use in flotation. Although in practical applications water or aqueous solutions are often used as flotation liquids, other types of liquid substances may also be utilized, as known to the skilled person.

Herein, a “unit” may refer to a device suitable for or configured to perform at least one specific process. Naturally, a “flotation unit” may then refer to a unit suitable for or configured to subject material to flotation, and/or a “fluidized-bed flotation unit” may refer to a unit suitable for or configured to subject material to fluidized-bed flotation. A unit may generally comprise one or more parts, and each of the one or more parts may be classified as belonging to an arrangement of said unit.

An “arrangement” of a unit configured to perform a process may refer to a set of parts of said unit suitable for or configured to perform at least one specific subprocess of said process. As such, a “unit comprising an arrangement” may refer to said unit comprising parts belonging to said arrangement. Generally, an arrangement may comprise any component(s), for example, mechanical, electrical, pneumatic, and/or hydraulic component(s), necessary and/or beneficial for performing its specific subprocess.

In this specification, a “tank” may refer to a receptacle suitable for or configured to hold a fluid, for example, a liquid.

Throughout this specification, a “launder” may refer to a trough arranged at an upper section of a tank for collecting a flotation product from said tank. Typically, a launder comprises a launder lip. Herein, a “launder lip” may refer to a part of a launder over which a flotation product is arranged to flow into said launder for collection.

In this specification, an “outlet” may refer to a means of discharge, e.g., an opening or a through-hole, for a fluid. Generally, an outlet may be arranged in a tank in any suitable manner, for example, at a side wall or at a bottom of a tank, or at an end of a pipe or other suitable conduit for passing fluid through a side wall or a bottom of a tank, or at an end of a pipe or other suitable conduit for passing fluid over a side wall of a tank.

As such, a “fine slurry outlet” may refer to an outlet configured to or suitable for passing fine slurry out of a tank. A fine slurry outlet may additionally be configured to or suitable for passing any other suitable type(s) of slurry, for example, coarse slurry, and/or pristine slurry, into a tank of a flotation unit. Typically, a fine slurry outlet is arranged at an upper section of a tank below a launder lip and above a coarse slurry outlet.

Similarly, a “coarse slurry outlet” may refer to an outlet configured to or suitable for passing coarse slurry out of a tank. A coarse slurry outlet may additionally be configured to or suitable for passing any other suitable type(s) of slurry, for example, fine slurry, and/or pristine slurry, out of a tank of a flotation unit. Typically, a coarse slurry outlet is arranged at a lower section of a tank for collecting a flotation product from said tank.

Generally, a fine slurry outlet may enable collecting from a volume of slurry mainly coarser particles of a first type, e.g., mineral particles, and finer particles of a second type, e.g., gangue particles, which may be further separated with relative ease. Additionally or alternatively, a fine slurry outlet may be utilized to provide a discharge path from said tank such that a fluidized bed may extend below said fine slurry outlet.

Throughout this specification, “solid-liquid separation” may refer to separation of suspended solid particles and flotation liquid from slurry. Consequently, a “solid-liquid separation arrangement” may refer to an arrangement of parts of a flotation unit configured to or suitable for solid-liquid separation of slurry.

Further, a “solids portion” formed by separation of suspended solid particles and flotation liquid from slurry may refer to a fraction of said slurry, resulting from solid-liquid separation of said slurry, wherein at least 90% by mass, or at least 95% by mass, or at least 98% by mass of suspended solid particles in said slurry have been collected into said fraction. Herein, a “fraction” may refer to a part of a mixture resulting from separation of said mixture.

On the other hand, a “liquid portion” formed by separation of suspended solid particles and flotation liquid from slurry may refer to a fraction of said slurry, resulting from solid-liquid separation of said slurry and comprising at least 90% by mass, or at least at least 95% by mass, or at least 98% by mass, or at least 99% by mass of flotation liquid.

Generally, a fluidized-bed flotation unit comprising a solid-liquid separation arrangement configured to collect output slurry from a volume of slurry via a fine slurry outlet and to separate suspended solids and flotation liquid from the output slurry to form a solids portion and a liquid portion may facilitate further flotation of said solids portion. Additionally or alternatively, a fluidized-bed flotation unit comprising such solid-liquid separation arrangement may enable channeling flotation liquid from output slurry within a mineral processing apparatus in order to maintain a device or unit with a higher flotation liquid consumption operational.

In an embodiment of the first aspect, the solid-liquid separation arrangement is configured to guide the solids portion out of the fluidized-bed flotation unit.

Generally, a solid-liquid separation arrangement of a fluidized-bed flotation unit being configured to guide a solids portion out of said fluidized-bed flotation unit may enable further processing, e.g., flotation, of solid particles in said solids portion at a distance from said fluidized-bed flotation unit.

In an embodiment of the first aspect, the solids portion has a solids fraction, ϕ^{sp}, greater than or equal to 0.2, or greater than or equal to 0.3 or greater than or equal to 0.4.

Generally, a solids portion having a sufficiently high solids fraction may facilitate flotation of said solids portion.

Herein, a “solids fraction” may refer to a ratio between a mass (ms) of solids in a slurry sample and a mass (mₛ₁) of said slurry sample.

In an embodiment of the first aspect, the solid-liquid separation arrangement comprises a solid-liquid separation hydrocyclone.

Throughout this specification, a “hydrocyclone” or a “cyclone” may refer to a device suitable for separation of suspended solid particles in slurry. Typically, a hydrocyclone comprises a generally cylindrical feed section; an overflow pipe, extending upwardly from the feed section; and a generally conical base section, extending from the feed section and ending at an apex opening. During operation of a hydrocyclone, slurry is fed tangentially into the feed section in order to create a vortex inside said hydrocyclone. In a hydrocyclone, slurry fed into said hydrocyclone is parceled out as underflow and overflow.

Herein, “underflow” and “overflow” from a hydrocyclone may refer to product streams discharged via an apex opening and an overflow pipe of said hydrocyclone, respectively.

Throughout this specification, a “solid-liquid separation hydrocyclone” or a “dewatering hydrocyclone” may refer to a hydrocyclone configured to or suitable for solid-liquid separation of slurry. Generally, a solid-liquid separation hydrocyclone may have a cut-off particle size less than or equal to 10 μm, as measured under typical hydrocyclone operating conditions. Additionally or alternatively, a solid-liquid separation hydrocyclone may have an internal diameter, measured across its feed section, less than 8 cm.

Herein, a “cut-off particle size” of a hydrocyclone may refer to a particle size such that a first half and a second half of solid particles in feed slurry of said particle size report to underflow and overflow of said hydrocyclone, respectively. Generally, solid particles smaller than the cut-off particle size are preferentially directed to overflow, whereas solid particles larger than the cut-off particle size are preferentially directed to underflow.

Further, “typical hydrocyclone operating conditions” may refer, at least, to holding a hydrocyclone upright; usage of feed slurry, consisting substantially of water and spherical particles with a density of 2650 kg/m3 at a feed slurry solids fraction of 0.02; and maintaining a pressure drop of 70 kPa. Although a cut-off particle size of a hydrocyclone may be measured under typical hydrocyclone operating conditions, any hydrocyclone may or may not be operated under typical hydrocyclone operating conditions in a flotation unit.

Generally, a solid-liquid separation arrangement comprising a solid-liquid separation hydrocyclone may simplify said solid-liquid separation arrangement and/or provide a higher throughput with a reduced footprint.

In an embodiment of the first aspect, the solid-liquid separation hydrocyclone has a cut-off particle size, d₅₀^{sl}, less than or equal to 10 μm, or less than or equal to 8 μm, or less than or equal to 6 μm, as measured under typical hydrocyclone operating conditions.

Generally, a cut-off particle size, d₅₀^{sl}, less than or equal to 10 μm, or less than or equal to 8 μm, or less than or equal to 6 μm, as measured under typical hydrocyclone operating conditions, may provide an advantageous separation of output slurry to form a solids portion and a liquid portion, even with a single solid-liquid separation stage.

In an embodiment of the first aspect, the fluidized-bed flotation unit comprises a circulation arrangement for circulating flotation liquid from the liquid portion back into the tank.

Throughout this specification, “circulation” may refer to passage of a fluid along a generally loop-shaped path. Generally, circulation may be intermittent, repeated (e.g., periodic), or continuous.

As such, a “circulation arrangement” may refer to an arrangement of a flotation unit configured to suitable for circulation of flotation liquid collected from a tank of said flotation unit back into said tank. Generally, flotation liquid may be fed back into a tank by a circulation arrangement in any suitable form(s), for example, in liquid form and/or as a part of slurry or a slurry-flotation gas mixture.

Generally, a flotation unit comprising a circulation arrangement may enable forming an internal slurry feed-back loop for a tank, which may increase recovery of solid particles from slurry. Additionally or alternatively, a circulation arrangement may reduce consumption of flotation liquid of a fluidized-bed flotation unit.

In an embodiment of the first aspect, the liquid portion has a solids fraction, φ^{lp}, less than or equal to 0.1, or less than or equal to 0.05, or less than or equal to 0.02, or less than or equal to 0.01.

Generally, a liquid portion having a lower solids fraction may facilitate usage of said liquid portion in maintaining device(s) and/or unit(s) with a higher flotation liquid consumption(s) operational.

In an embodiment of the first aspect, the tank comprises a circulation inlet and the circulation arrangement is configured to feed flotation liquid from the liquid portion back into the tank via the circulation inlet.

Throughout this specification, an “inlet” may refer to a means of entry, e.g., an opening or a through-hole, for a fluid. Generally, an inlet may be arranged in a tank in any suitable manner, for example, at a side wall or at a bottom of a tank, or at an end of a pipe or other suitable conduit for passing fluid through a side wall or a bottom of a tank, or at an end of a pipe or other suitable conduit for passing fluid over a side wall of a tank.

Consequently, a “circulation inlet” may refer to an inlet configured to or suitable for introducing fluid propagating along a generally loop-shaped path into a tank. Additionally or alternatively, a circulation inlet of a tank may be configured to or suitable for feeding flotation liquid collected from said tank back into said tank. Generally, flotation liquid may be fed through a circulation inlet of a tank as a fluid, comprising flotation liquid and, optionally, one or more of flotation gas and solid particles collected from said tank.

Generally, circulating flotation liquid by feeding it into a tank via a circulation inlet separate from any inlet through which slurry is fed into said tank may enable operating a circulation arrangement independently, which may, in turn, increase a reliability of a flotation unit.

In an embodiment of the first aspect, the fluidized-bed flotation unit comprises a flotation gas supply arrangement configured to supply flotation gas into the volume of slurry by injecting flotation gas to flotation liquid, which the circulation arrangement is configured to feed back into the tank via the circulation inlet.

In this disclosure, a “flotation gas supply arrangement” may refer to an arrangement of parts of a flotation unit suitable for or configured to supply flotation gas into a tank of said flotation unit. Generally, a flotation gas supply arrangement may comprise any part(s) suitable or necessary for supplying flotation gas into a tank, for example, one or more spargers, e.g., jetting and/or cavitation sparger(s), and/or one or more static mixer(s).

In an embodiment of the first aspect, the fluidized-bed flotation unit comprises a first slurry feeding arrangement for feeding primary slurry into the volume of slurry, and the circulation arrangement is configured to circulate flotation liquid from the liquid portion back into the tank by adding such flotation liquid to primary slurry, which the first slurry feeding arrangement is configured to feed into the volume of slurry.

Herein, a “first slurry feeding arrangement” may refer to an arrangement of parts of a flotation unit suitable for or configured to feed slurry into a tank of said flotation unit by feeding said slurry into a volume of slurry. Generally, primary slurry fed into a tank of a flotation unit by a first slurry feeding arrangement may comprise any suitable type of slurry, for example, fine slurry, or coarse slurry, or pristine slurry. A first slurry feeding arrangement may or may not be configured to feed primary slurry into a tank of a flotation unit below a fine slurry outlet and/or at a lower section of said tank.

Generally, circulating flotation liquid by adding it to fine slurry to be fed into a tank by a first slurry feeding arrangement may simplify the structure of a flotation unit.

In an embodiment of the first aspect, the fluidized-bed flotation unit comprises a second slurry feeding arrangement for feeding secondary slurry into the tank.

Herein, a “second slurry feeding arrangement” may refer to an arrangement of parts of a flotation unit suitable for or configured to feed slurry into a tank of said flotation unit. Generally, secondary slurry fed into a tank of a flotation unit by a second slurry feeding arrangement may comprise any suitable type of slurry, for example, fine slurry, or coarse slurry, or pristine slurry. A second slurry feeding arrangement may or may not be configured to feed secondary slurry into a tank of a flotation unit above a fine slurry outlet and/or at an upper section of said tank. Similarly, a second slurry feeding arrangement may or may not be configured to feed secondary slurry to a froth layer. In some embodiments, secondary slurry fed into a tank by a second slurry feeding arrangement may be coarser, for example, based on a comparison of p₈₀ values, than primary slurry fed into a tank by a first slurry feeding arrangement.

In an embodiment of the first aspect, the tank has a height, H, and the fluidized-bed flotation unit is configured to feed secondary slurry into the tank within an upper 40% of the height, H, of the tank.

Herein, a “height” of a tank may refer to a vertical distance between a launder lip and a bottom of said tank, when said tank is arranged upright. Similarly, any “vertical distance” between any two parts of a tank may be generally be measured with said tank being arranged upright.

Generally, feeding secondary slurry within an upper 40% of the height, H, of the tank may increase collection efficiency of a fluidized-bed flotation unit.

In an embodiment of the first aspect, the second slurry feeding arrangement is configured to feed secondary slurry into the tank above the fine slurry outlet.

Generally, feeding secondary slurry into a tank above a fine slurry outlet may increase a settling distance of particulate matter in said secondary slurry within a fluidized bed, which may, in turn, increase recovery of a fluidized-bed flotation unit.

In an embodiment of the first aspect, the second slurry feeding arrangement is configured to feed secondary slurry to a froth layer formed in the tank over the volume of slurry.

Herein, “froth” may refer to a dispersion, comprising a greater portion by volume of flotation gas dispersed as bubbles in lesser portion by volume of a flotation liquid. Generally, froth may or may not be stabilized by solid particles. In froth, flotation gas bubbles may generally have an average diameter greater than or equal to 1 mm. Additionally or alternatively, an average distance between neighboring flotation gas bubbles in froth not stabilized by solid particles may generally be less than or equal to some tens of micrometers, for example, less than or equal to 50 μm or 30 μm. Naturally, in froth stabilized by solid particles, average distance between neighboring flotation gas bubbles is increased in proportion to the average size and quantity of said solid particles.

In this disclosure, a “layer” may refer to a generally sheet-formed element arranged on a surface. A layer may or may not be path-connected. Some layers may be locally path-connected and disconnected. Although a layer may generally comprise a plurality of sublayers of different material compositions, a “froth layer” may refer to a layer comprising, or comprising substantially, or consisting essentially of, or consisting of froth.

Further, slurry being “fed to a froth layer” may refer to feeding said slurry onto, and/or into, and/or immediately below, e.g., at most 50 cm, or at most 40 cm, or at most 30 cm, or at most 20 cm, or at most 10 cm below, said froth layer. Additionally or alternatively, in embodiments, wherein a height of a launder lip defines a height of an upper surface of a froth layer, slurry being fed to said froth layer may refer to feeding said slurry into a tank at said launder lip height and/or at a position at most 60 cm, or at most 50 cm, or at most 40 cm, or at most 30 cm, or at most 20 cm below said launder lip height.

Generally, when slurry is fed to a froth layer and a fluidized bed is maintained in a volume of slurry below said froth layer, coarser particles in said slurry that have inadvertently dropped into said volume of slurry may settle through said fluidized bed and may be recollected efficiently to said froth layer.

In an embodiment of the first aspect, the tank comprises a secondary slurry inlet above the fine slurry outlet, and the second slurry feeding arrangement is configured to feed secondary slurry into the tank via the secondary slurry inlet.

In this specification, a “secondary slurry inlet” may refer to an inlet configured to or suitable for passing secondary slurry into a tank. A secondary slurry inlet may be arranged above a fine slurry outlet.

In an embodiment of the first aspect, the tank comprises a tertiary slurry inlet arranged at the height of the fine slurry outlet or immediately below the fine slurry outlet, and the second slurry feeding arrangement is configured to feed secondary slurry into the tank via the tertiary slurry inlet.

Generally, arranging a tertiary slurry inlet at a height of a fine slurry outlet or immediately below, e.g., at most 50 cm, or at most 40 cm, or at most 30 cm, or at most 20 cm, or at most 10 cm below, said fine slurry outlet may reduce short-circuiting of secondary slurry fed into a tank said tertiary slurry inlet.

In an embodiment of the first aspect, the fluidized-bed flotation unit comprises a classification arrangement configured to classify input slurry to form a coarser slurry fraction and a finer slurry fraction, to feed the coarser slurry fraction to the second slurry feeding arrangement, and to channel the finer slurry fraction to be fed into the volume of slurry below the fine slurry outlet.

Throughout this specification, “classification” may refer to sizing of solid particles in slurry to form at least two, i.e., two, three, or more, slurry fractions based on differences in the settling velocities of solid particles in said slurry. In practice, classification of slurry results in coarser particles in said slurry being preferentially directed to one or more coarser slurry fractions and finer particles in said slurry being preferentially directed to one or more finer slurry fractions. Naturally, a “classification arrangement” may then refer to an arrangement of parts of a flotation unit configured to or suitable for classification of slurry.

Further, a “slurry fraction” may refer to a fraction, comprising slurry and resulting from separation of slurry; a “coarser slurry fraction” may refer to a slurry fraction, comprising solid particles of a larger median size by mass; and a “finer slurry fraction” may refer to a slurry fraction, comprising solid particles of a median size by mass smaller than the larger median size by mass of a coarser slurry fraction.

Generally, a classification arrangement of a fluidized-bed flotation unit being configured to feed a coarser slurry fraction to a second slurry feeding arrangement and to channel a finer slurry fraction to be fed into a volume of slurry below a fine slurry outlet may increase throughput and/or overall collection efficiency of said fluidized-bed flotation unit.

In an embodiment of the first aspect, the fluidized-bed flotation unit comprises a flotation liquid supply arrangement for supplying flotation liquid into the volume of slurry.

In this disclosure, a “flotation liquid supply arrangement” may refer to an arrangement of parts of a flotation unit configured to or suitable for supplying flotation liquid into a tank of a flotation unit from a source external to the flotation unit, e.g., a process water unit of a mineral processing apparatus or a body of water.

Generally, a flotation unit comprising a flotation liquid supply arrangement may facilitate maintaining a top surface of a volume of slurry at a set distance from a launder lip of a launder of a tank. Additionally of alternatively, a flotation unit comprising a flotation liquid supply arrangement may facilitate controlling viscosity of slurry in a tank.

In an embodiment of the first aspect, the tank comprises a downwardly tapering bottom cone, and the coarse slurry outlet is arranged at the bottom of the bottom cone.

Throughout this specification, a “bottom cone” of a tank may refer to a generally funnel-shaped and downwardly tapering bottom structure of said tank suitable for or configured to guide settled solid particles towards an outlet or an inlet.

Generally, a tank comprising a bottom cone and a coarse slurry outlet at the bottom of said bottom cone may facilitate discharge of extremely coarse slurry out of said tank and/or reduce sanding in said tank.

In an embodiment of the first aspect, the fluidized-bed flotation unit comprises a slurry agitation arrangement for agitating the volume of slurry.

Throughout this specification, a “agitation” may refer stirring, mixing and/or disturbing a fluid, e.g., a liquid. Consequently, a “slurry agitation arrangement” may refer to an arrangement of parts of a flotation unit configured to or suitable for agitation of slurry.

Generally, a slurry agitation arrangement may increase a homogeneity of a volume of slurry in a tank. Additionally or alternatively, a fluidized-bed flotation unit comprising a slurry agitation arrangement may facilitate maintaining a fluidized bed in a volume of slurry in a tank.

According to a second aspect, this disclosure relates to use of a fluidized-bed flotation unit according to the first aspect or any embodiment thereof for separation of a valuable material suspended in slurry.

In an embodiment of the second aspect, this disclosure relates to use of a fluidized-bed flotation unit according to the first aspect or any embodiment thereof for separation of particles, comprising copper (Cu), from low-grade ore.

According to a third aspect, a mineral processing apparatus, comprising a fluidized-bed flotation unit according to the first aspect or any embodiment thereof, is provided.

Throughout this specification, an “apparatus” may refer to equipment suitable for or configured to perform a systematic series of processes. An apparatus may comprise any suitable number, for example, one or more, units. Consequently, a mineral processing apparatus” may refer to an apparatus suitable for or configured to separation of mineral(s) from ore. A mineral processing apparatus may generally comprise any unit(s) suitable or necessary for flotation and, optionally, any unit(s) suitable or necessary for pre-treating material prior to flotation and/or post-treating material following flotation.

In an embodiment of the third aspect, the mineral processing apparatus comprises a comminution unit configured to grind ore to form ground ore, to mix the ground ore with flotation liquid to form pristine slurry, and to feed the pristine slurry to the fluidized-bed flotation unit.

Throughout this specification, “comminution” may refer to any action(s) taken in order to reduce an average particle size of solid material. As such, comminution may comprise, for example, crushing and/or grinding. In mineral processing, comminution is commonly used for liberation of valuable mineral(s) from gangue. Consequently, a “comminution unit” may refer to a device suitable for or configured to reduce an average particle size of a solid material.

Generally, a comminution unit being configured to feed pristine slurry to a fluidized-bed flotation unit may allow removal of a larger amount of gangue at an earlier stage, which may, in turn simplify the structure of a mineral processing apparatus downstream from said fluidized-bed flotation unit and/or reduce overall energy and/or flotation liquid consumption of said mineral processing apparatus. A fluidized-bed flotation unit in accordance with this specification may be particularly suited for flotation of slurry with a broader particle size distribution. As such, a comminution unit may feed such fluidized-bed flotation unit with pristine slurry, which may have a particle size distribution dictated mainly by characteristics of comminution processes performed by said comminution unit. As known to the skilled person, such particle size distribution may (substantially) follow, for example, a so-called Weibull distribution, also referred to as a Rosin-Rammler distribution in relation to mineral processing.

In an embodiment of the third aspect, the mineral processing apparatus comprises a comminution unit, a pre-classification unit, and a primary flotation unit. The comminution unit is configured to grind ore to form ground ore, to mix the ground ore with flotation liquid to form pristine slurry, and to feed the pristine slurry to the pre-classification unit. The pre-classification unit is configured to classify the pristine slurry to form a coarser pristine slurry fraction and a finer pristine slurry fraction and to feed the finer pristine slurry fraction to the primary flotation unit. The primary flotation unit is configured to separate the finer pristine slurry fraction to form an overflow and an underflow and to feed the underflow to the fluidized-bed flotation unit.

Generally, in standard flotation, underflow from a primary flotation unit may comprise a considerable amount of coarser particles of valuable mineral(s) mixed with finer gangue particles. Since a fluidized-bed flotation unit in accordance with this specification may be particularly suited for flotation of slurry with a broader particle size distribution, a primary flotation unit being configured to feed its underflow to a fluidized-bed flotation unit in accordance with this specification may facilitate further flotation of said underflow. Naturally, similar considerations apply, mutatis mutandis, in case of reverse flotation.

In an embodiment of the third aspect, the mineral processing apparatus comprises a secondary flotation unit, and the fluidized-bed flotation unit is configured to pass slurry from the solids portion for further flotation at the secondary flotation unit.

Generally, feeding a solids portion to a secondary flotation unit may enable reducing consumption of flotation liquid in a mineral processing apparatus by sending readily separable slurry to a flotation unit with a consumption of flotation liquid lower than that of a typical fluidized-bed flotation unit. Additionally or alternatively, feeding a solids portion of slurry collected from a fine slurry outlet of a tank to a secondary flotation unit may facilitate separation of valuable mineral(s) from said slurry due to a reduced flotation liquid content of such solids portion.

According to a fourth aspect, a fluidized-bed flotation method is provided. The fluidized-bed flotation method comprises providing a tank for holding a volume of slurry, the tank comprising a launder with a launder lip; collecting output slurry from the volume of slurry at a first height, h₁, below the launder lip; and collecting coarse output slurry (5300) from the volume of slurry at a second height, h₂, below the first height, h₁. The fluidized-bed flotation method further comprises separating suspended solids and flotation liquid from the output slurry to form a solids portion and a liquid portion.

In an embodiment of the fourth aspect, the fluidized-bed flotation method comprises passing slurry from the solids portion for further flotation at a distance from the tank.

In an embodiment of the fourth aspect, the solids portion has a solids fraction, ϕ^{sp}, greater than or equal to 0.2, or greater than or equal to 0.3 or greater than or equal to 0.4.

In an embodiment of the fourth aspect, the fluidized-bed flotation method comprises circulating flotation liquid from the liquid portion back into the tank. In an embodiment of the fourth aspect, the liquid portion has a solids fraction, ϕ^{lp}, less than or equal to 0.1, or less than or equal to 0.05, or less than or equal to 0.02, or less than or equal to 0.01.

### BRIEF DESCRIPTION OF THE DRAWINGS

The present disclosure will be better understood from the following detailed description read in light of the accompanying drawings, wherein:

FIG. 1 shows a schematic view of a fluidized-bed flotation unit,

FIG. 2 depicts a schematic view of another fluidized-bed flotation unit, and

FIG. 3 shows a schematic view of a mineral processing apparatus,

FIG. 4 depicts a schematic view of another mineral processing apparatus, and

FIG. 5 illustrates a fluidized-bed flotation method.

Unless specifically stated to the contrary, any drawing of the aforementioned drawings may be not drawn to scale such that any element in said drawing may be drawn with inaccurate proportions with respect to other elements in said drawing in order to emphasize certain structural aspects of the embodiment of said drawing.

Moreover, corresponding elements in the embodiments of any two drawings of the aforementioned drawings may be disproportionate to each other in said two drawings in order to emphasize certain structural aspects of the embodiments of said two drawings.

### DETAILED DESCRIPTION

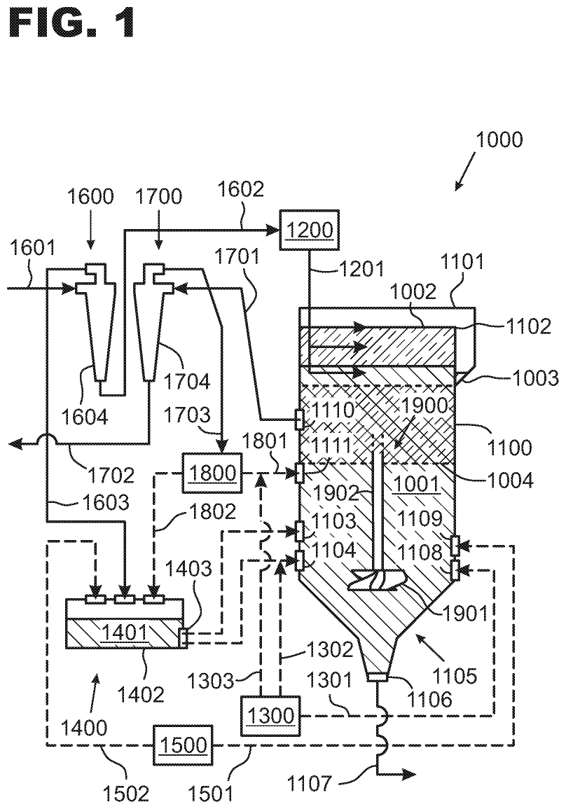

FIG. 1 depicts a fluidized-bed flotation unit 1000 according to an embodiment.

The fluidized-bed flotation unit 1000 of the embodiment of FIG. 1 may be used in so-called “standard flotation”, wherein valuable mineral(s) in input slurry 1601 is collected as overflow and gangue is directed to underflow.

In other embodiments, a fluidized-bed flotation unit may be used in any suitable manner, for example, in standard flotation and/or in so-called “reverse flotation”, wherein valuable mineral(s) in input slurry is directed to underflow and gangue is collected as overflow.

The fluidized-bed flotation unit 1000 of the embodiment of FIG. 1 may specifically be used in so-called “coarse flotation”, wherein slurry comprising a considerable amount of coarser solid particles is used as feed material for flotation.

In the embodiment of FIG. 1, the fluidized-bed flotation unit 1000 comprises a tank 1100.

The tank 1100 of the embodiment of FIG. 1 is configured to hold a volume of slurry 1001 and a froth layer 1002 over the volume of slurry 1001. When the fluidized-bed flotation unit 1000 is in use, a fluidized bed 1004 is maintained in the volume of slurry 1001. Generally, maintaining a fluidized bed in a tank of a flotation unit may increase recovery of coarser particles. In other embodiments, a tank may or may not be configured to or suitable for holding a froth layer over a volume of slurry.

Although a single tank is depicted in FIG. 1, a fluidized-bed flotation unit may generally comprise one or more, e.g., one, two, three, four, etc., tanks.

The tank 1100 of the embodiment of FIG. 1 comprises a launder 1101, which comprises a launder lip 1102. The launder 1101 is configured to collect froth 1003 from the froth layer 1002. In other embodiments, a launder may or may not be configured to collect froth from a froth layer.

The fluidized-bed flotation unit 1000 may be configured to maintain a froth depth, d^{f}, of approximately 10 cm for the froth layer 1002. In other embodiments, any suitable d^{f}, for example, a d^{f} of zero or substantially zero, e.g., less than 2 cm, or less than 1 cm, or less than 0.5 cm, or a d^{f} in a range from 2 cm to 20 cm, may be used.

Herein, a “froth depth” may refer to a thickness of a froth layer in a tank, measured as a vertical distance between a launder lip and a surface of a volume of slurry in said tank, when said tank is in use.

The tank 1100 of the embodiment of FIG. 1 comprises a primary slurry inlet 1103. In other embodiments, a tank may or may not comprise such primary slurry inlet.

In this specification, a “primary slurry inlet” may refer to an inlet configured to or suitable for passing primary slurry into a tank.

The tank 1100 of the embodiment of FIG. 1 comprises a primary slurry-flotation gas mixture inlet 1104. In other embodiments, a tank may or may not comprise such primary slurry-flotation gas mixture inlet.

In this disclosure, a “primary slurry-flotation gas mixture inlet” may refer to an inlet configured to or suitable for passing a mixture of primary slurry and flotation gas into a tank.

The tank 1100 of the embodiment of FIG. 1 comprises a coarse slurry outlet 1106 for discharging coarse output slurry 1107 from the volume of slurry 1001.

The coarse slurry outlet 1106 of the embodiment may have an opening diameter, dₒ^{cs}, of approximately 10 cm. Generally, a coarse slurry outlet with a higher dₒ^{cs} may facilitate passage of coarser solid particles via said coarse slurry outlet, which may, in turn, facilitate flotation of (extremely) coarse slurry. In other embodiments, a coarse slurry outlet may have any suitable dₒ^{cs}, for example, an dₒ^{cs} in a range from 2 cm to 20 cm.

Herein, an “opening diameter” may refer to a shortest transverse measurement of an opening, measured perpendicular to an intended fluid flow direction through said opening.

In the embodiment of FIG. 1, the tank 1100 comprises a downwardly tapering bottom cone 1105. Generally, a tank comprising a bottom cone may reduce sanding in said tank. In other embodiments, a tank may or may not comprise such bottom cone.

In the embodiment of FIG. 1, the coarse slurry outlet 1106 is arranged at the bottom of the bottom cone 1105. In other embodiments, a coarse slurry outlet may be arranged in any suitable manner, for example, at the bottom of a bottom cone. For example, in some embodiments, a tank may comprise a flat bottom; a side wall, extending from said bottom; and a coarse slurry outlet arranged at said side wall. In some embodiments, a tank may comprise a bottom cone and a primary slurry inlet at the bottom of said bottom cone.

The tank 1100 of the embodiment of FIG. 1 comprises a flotation gas inlet 1108. In other embodiments, a tank may or may not comprise such flotation gas inlet.

Herein, a “flotation gas inlet” may refer to an inlet configured to or suitable for passing flotation gas into a tank.

The flotation gas inlet 1108 of the embodiment is arranged below the primary slurry inlet 1103. Generally, arranging a flotation gas inlet below a primary slurry inlet may increase recovery of solid particles passed into a tank via said primary slurry inlet. In other embodiments, a flotation gas inlet and a primary slurry inlet may be arranged in any suitable manner, for example, such that said flotation gas inlet is arranged below said primary slurry inlet.

The tank 1100 of the embodiment of FIG. 1 comprises a fine slurry outlet 1110 for collecting output slurry 1701 from the volume of slurry 1001. The fine slurry outlet 1110 is arranged below the launder lip 1102 and above the coarse slurry outlet 1106.

In the embodiment of FIG. 1, the output slurry 1701 collected from the volume of slurry 1001 via the fine slurry outlet 1110 may comprise fine gangue particles and coarse particles of valuable mineral(s). In other embodiments, output slurry collected from a volume of slurry via a fine slurry outlet may comprise any suitable type(s) of particles, for example, fine gangue particles and coarse particles of valuable mineral(s) or fine particles of valuable mineral(s) and coarse gangue particles.

The tank 1100 of the embodiment of FIG. 1 comprises a flotation liquid inlet 1109. In other embodiments, a tank may or may not comprise such flotation liquid inlet.

Herein, a “flotation liquid inlet” may refer to an inlet configured to or suitable for passing flotation liquid into a tank.

The flotation liquid inlet 1109 of the embodiment is arranged below the fine slurry outlet 1110. Generally, arranging a flotation liquid inlet below a fine slurry outlet may enable utilization of flotation liquid fed into a tank via said flotation liquid inlet in maintaining said fluidized bed. In other embodiments, a flotation liquid inlet may be arranged in any suitable manner, for example, below a fine slurry outlet.

The tank 1100 of the embodiment of FIG. 1 comprises a circulation inlet 1111. In other embodiments, a tank may or may not comprise such circulation inlet.

The circulation inlet 1111 of the embodiment of FIG. 1 is arranged below the fine slurry outlet 1110. Generally, arranging a circulation inlet below a fine slurry outlet may enable utilization of flotation liquid fed into a tank via said circulation inlet in maintaining a fluidized bed. In other embodiments, a circulation inlet may be arranged in any suitable manner, for example, below a fine slurry outlet.

Although in FIG. 1 the fluidized bed 1004 extends from above the circulation inlet 1111 to above the fine slurry outlet 1110, a fluidized bed may generally be arranged in a tank of a fluidized-bed flotation unit in any suitable manner, for example, to extend between any suitable horizontal levels of a tank.

In the embodiment of FIG. 1, the fluidized-bed flotation unit 1000 comprises a solid-liquid separation arrangement 1700 configured to collect output slurry 1701 from the volume of slurry 1001 via the fine slurry outlet 1110 and to separate suspended solids and flotation liquid from the output slurry 1701 to form a solids portion 1702 and a liquid portion 1703.

The solid-liquid separation arrangement 1700 of the embodiment of FIG. 1 is configured to guide the solids portion 1702 out of the fluidized-bed flotation unit 1000, for example, to a further flotation unit. In other embodiments, a solid-liquid separation arrangement may or may not be configured to guide a solids portion out of said fluidized-bed flotation unit. For example, in some embodiments, solid particles in output slurry collected via a fine slurry outlet may be channeled from a solid-liquid separation arrangement to a classification arrangement (see below).

The solid-liquid separation arrangement 1700 of the embodiment of FIG. 1 is configured to feed the liquid portion 1703 to a circulation arrangement 1800 of the fluidized-bed flotation unit 1000 (see below). In other embodiments, a solid-liquid separation arrangement may or may not be configured to feed a liquid portion to a circulation arrangement.

Although not depicted in FIG. 1, a solid-liquid separation arrangement may generally be configured to separate suspended solids and flotation liquid from output slurry so that product(s) other than a solids portion and a liquid portion are also formed. In such case, a solid-liquid separation arrangement may be configured to channel such other product(s) to any suitable location(s), arrangement(s), or unit(s).

In the embodiment of FIG. 1, the solids portion 1702 may have a solids fraction, ϕ^{sp}, of approximately 0.3. In other embodiments, a solids portion may have any suitable solids fraction, for example, a solids fraction greater than or equal to 0.2, or greater than or equal to 0.3 or greater than or equal to 0.4.

In the embodiment of FIG. 1, the liquid portion 1703 may have a solids fraction, ϕ^{lp}, of approximately 0.05. In other embodiments, a liquid portion may have any suitable solids fraction, for example, a solids fraction less than or equal to 0.1, or less than or equal to 0.05, or less than or equal to 0.02, or less than or equal to 0.01.

The solid-liquid separation arrangement 1700 of the embodiment of FIG. 1 comprises a solid-liquid separation hydrocyclone 1704. In other embodiments, a solid-liquid separation arrangement may or may not comprise a solid-liquid separation hydrocyclone.

In some embodiments, in addition to or as an alternative to a solid-liquid separation hydrocyclone, a solid-liquid separation arrangement may comprise one or more of a gravitational sedimentation device, e.g., a thickener or a inclined plate settler; a centrifuge; and a filtration device, e.g., a pressure filter, a tube press, a vacuum filter, or a rotary-drum filter.

The solid-liquid separation hydrocyclone 1704 of the embodiment of FIG. 1 may have a cut-off particle size, d₅₀^{sl}, of approximately 10 μm, as measured under typical hydrocyclone operating conditions. In other embodiments, a solid-liquid separation hydrocyclone may have any suitable d₅₀^{sl}, for example, a d₅₀^{sl} less than or equal to 10 μm, or less than or equal to 8 μm, or less than or equal to 6 μm, as measured under typical hydrocyclone operating conditions.

In the embodiment of FIG. 1, the fluidized-bed flotation unit 1000 comprises a circulation arrangement 1800 for circulating flotation liquid 1801, 1802 collected from the tank 1100 via the fine slurry outlet 1110 back into the tank 1100. In other embodiments, a fluidized-bed flotation unit may or may not comprise such circulation arrangement.

The circulation arrangement 1800 of the embodiment of FIG. 1 is configured to supply flotation liquid 1801, 1802 collected from the tank 1100 via the fine slurry outlet 1110 back into the tank 1100 such that said flotation liquid 1801, 1802 is reintroduced into the tank 1100 below the fine slurry outlet 1110. Generally, configuring a circulation arrangement to supply flotation liquid collected from a tank via a fine slurry outlet back into said tank such that said flotation liquid is introduced into said tank below a fine slurry outlet may enable utilizing circulation of flotation liquid for maintaining a fluidized bed in said tank. In other embodiments, a circulation arrangement may be configured to supply flotation liquid collected from a tank via a fine slurry outlet back into said tank in any suitable manner, for example, such that said flotation liquid is introduced into said tank below a fine slurry outlet.

As indicated in FIG. 1 using dashed arrows, the circulation arrangement 1800 of the embodiment of FIG. 1 may be configured to feed flotation liquid 1801 collected from the tank 1100 via the fine slurry outlet 1110 back into the tank 1100 via the circulation inlet 1111 and/or to add such flotation liquid 1802 to primary slurry 1401, which the first slurry feeding arrangement 1400 is configured to feed into the volume of slurry 1001. In other embodiments, a circulation arrangement may or may not be configured in such manner.

The circulation arrangement 1800 of the embodiment of FIG. 1 may be specifically configured to add flotation liquid 1802 collected from the tank 1100 via the fine slurry outlet 1110 to primary slurry 1401, which the first slurry feeding arrangement 1400 is configured to feed into the volume of slurry 1001, by feeding said flotation liquid 1802 into a slurry sump 1402 (see below). In other embodiments, a circulation arrangement may be configured to add flotation liquid to fine slurry to be fed into a tank by a first slurry feeding arrangement in any suitable manner, for example, by feeding said flotation liquid into a slurry sump.

The circulation arrangement 1800 of the embodiment of FIG. 1 is configured to receive the liquid portion 1703, which the solid-liquid separation arrangement 1700 is configured to channel to the circulation arrangement 1800. In other embodiments, a circulation arrangement may or may not be configured to receive a liquid portion formed by a solid-liquid separation arrangement through separation of suspended solids and flotation liquid from output slurry collected via a fine slurry outlet. For example, in some embodiments, a circulation arrangement may be configured to collect output slurry via a fine slurry outlet.

In the embodiment of FIG. 1, flotation liquid 1801, which the circulation arrangement 1800 may be configured to feed back into the tank 1100 via the circulation inlet 1111, and/or flotation liquid 1802, which the circulation arrangement 1800 may be configured to add to primary slurry 1401, which the first slurry feeding arrangement 1400 is configured to feed into the volume of slurry 1001, may be taken from the liquid portion 1703 channeled to the circulation arrangement 1800 by the solid-liquid separation arrangement 1700. In other embodiments, a circulation arrangement may or may not be configured to feed flotation liquid from a liquid portion back into a tank via a circulation inlet and/or to add flotation liquid from a liquid portion to fine slurry, which a first slurry feeding arrangement is configured to feed into a volume of slurry.

In the embodiment of FIG. 1, the fluidized-bed flotation unit 1000 comprises a first slurry feeding arrangement 1400. In other embodiments, a fluidized-bed flotation unit may or may not comprise a first slurry feeding arrangement.

As indicated by dashed arrows in FIG. 1, the first slurry feeding arrangement 1400 of the embodiment of FIG. 1 may be configured to feed primary slurry 1401 into the volume of slurry 1001 via the primary slurry inlet 1103 and/or via the primary slurry-flotation gas mixture inlet 1104. In other embodiments, a first slurry feeding arrangement may be suitable for or configured to feed fine slurry into a tank in any suitable manner, for example, by feeding fine slurry into a volume of slurry via a primary slurry inlet and/or a primary slurry-flotation gas mixture inlet.

The first slurry feeding arrangement 1400 of the embodiment of FIG. 1 comprises the slurry sump 1402, comprising a sump slurry outlet 1403 at a lower section of the slurry sump 1402. Generally, collecting fine slurry to be fed into a volume of slurry from a slurry sump may increase a solids fraction of fine slurry to be fed into said volume of slurry, which may, in turn, increase a solids fraction of coarse slurry collected via a coarse slurry outlet. This may contribute towards reducing consumption of flotation liquid in a flotation unit. In other embodiments, a first slurry feeding arrangement may or may not comprise such slurry sump.

In this disclosure, a “sump” may refer to a reservoir, e.g., a pit or a container, suitable for or configured to collecting and/or holding a liquid. As such, a “slurry sump” may refer to a sump for collecting and/or holding slurry.

The first slurry feeding arrangement 1400 of the embodiment of FIG. 1 is configured to collect primary slurry 1401 to be fed into the volume of slurry 1001 from the slurry sump 1402 via the sump slurry outlet 1403. In other embodiments, a first slurry feeding arrangement may or may not be arranged in such manner.

In the embodiment of FIG. 1, the fluidized-bed flotation unit 1000 comprises a classification arrangement 1600 configured to classify input slurry 1601 to form a coarser slurry fraction 1602 and a finer slurry fraction 1603. In other embodiments, a fluidized-bed flotation unit may or may not comprise such classification arrangement.

In the embodiment of FIG. 1, the fluidized-bed flotation unit 1000 comprises a second slurry feeding arrangement 1200. In other embodiments, a fluidized-bed flotation unit may or may not comprise a second slurry feeding arrangement.

The second slurry feeding arrangement 1200 of the embodiment of FIG. 1 is configured to feed secondary slurry 1201 into the tank 1100 above the fine slurry outlet 1110. In other embodiments, a second slurry feeding arrangement may or may not be configured in such manner.

The second slurry feeding arrangement 1200 of the embodiment of FIG. 1 is specifically configured to feed secondary slurry 1201 to the froth layer 1002. Consequently, the fluidized-bed flotation unit 1000 is implemented as a froth-interaction flotation unit. Generally, feeding secondary slurry to a froth layer may increase a recovery of mineral particles in said secondary slurry. In other embodiments, a second slurry feeding arrangement may be suitable for or configured to feed secondary slurry into a tank in any suitable manner, for example, by feeding said secondary slurry to a froth layer.

Throughout this specification, “froth flotation” may refer to flotation, wherein froth is utilized for separation. Further, “froth-interaction flotation” may refer to froth flotation, wherein slurry is fed to a froth layer. Consequently, a “froth-interaction flotation unit” may refer to a unit configured to or suitable for separation of material by froth-interaction flotation.

The classification arrangement 1600 of the embodiment of FIG. 1 is configured to feed the coarser slurry fraction 1602 to the second slurry feeding arrangement 1200 and to feed the finer slurry fraction 1603 to the first slurry feeding arrangement 1400, i.e., the coarser slurry fraction 1602 is configured to channel the finer slurry fraction 1603 to be fed into the volume of slurry 1001 below the fine slurry outlet 1110. In other embodiments, a classification arrangement may be configured in any suitable manner, for example, to feed a coarser slurry fraction to a second slurry feeding arrangement, and to channel a finer slurry fraction to be fed into the volume of slurry below a fine slurry outlet.

Although not depicted in FIG. 1, a classification arrangement may generally be configured to classify input slurry so that product(s) other than a coarser slurry fraction and a finer slurry fraction are also formed. In such case, a classification arrangement may be configured to channel such other product(s) to any suitable location(s), arrangement(s), or unit(s).

The classification arrangement 1600 of the embodiment of FIG. 1 is configured to feed the finer slurry fraction 1603 into the slurry sump 1402. In other embodiments, a classification arrangement may be configured to feed a finer slurry fraction to a first slurry feeding arrangement in any suitable manner, for example, by feeding said finer slurry fraction to a slurry sump of said first slurry feeding arrangement.

In the embodiment of FIG. 1, the finer slurry fraction 1603 may have a solids fraction, ϕ^{fs}, which is lower than the solids fraction, ϕ^{cs}, of the coarser slurry fraction 1602. In other embodiments, a finer slurry fraction fed by a classification arrangement to a first slurry feeding arrangement may or may not have a ϕ^{fs} lower than a ϕ^{cs} of a coarser slurry fraction fed by said classification arrangement to a second slurry feeding arrangement.

In the embodiment of FIG. 1, the coarser slurry fraction 1602 may have a solids fraction, ϕ^{cs}, of approximately 0.6. Generally, maintaining higher ϕ^{cs} is advantageous for froth-interaction flotation. In other embodiments, a coarser slurry fraction may have any suitable solids fraction, ϕ^{cs}, for example, a ϕ^{cs} in a range from 0.5 to 0.8, or in a range from 0.55 to 0.75 or in a range from 0.6 to 0.7.

In the embodiment of FIG. 1, the finer slurry fraction 1603 may have a solids fraction, ϕ^{fs}, of approximately 0.2. Generally, a lower ϕ^{fs} may facilitate introduction of slurry into a volume of slurry. In other embodiments, a finer slurry fraction may have any suitable solids fraction, ϕ^{fs}, for example, a ϕ^{fs} in a range from 0.05 to 0.35, or in a range from 0.1 to 0.25 or in a range from 0.15 to 0.2.

The classification arrangement 1600 of the embodiment of FIG. 1 comprises a classification hydrocyclone 1604. In other embodiments, a classification arrangement may or may not comprise a classification hydrocyclone.

In this disclosure, a “classification hydrocyclone” may refer to hydrocyclone configured to or suitable for classification of solid particles in a slurry. In mineral processing, classification hydrocyclones are typically used to separate coarser particles from finer particles in order to limit resource consumption of grinding circuits. Generally, a classification hydrocyclone may have a cut-off particle size greater than 10 μm, as measured under typical hydrocyclone operating conditions. Additionally or alternatively, a classification hydrocyclone may have an internal diameter, measured across its feed section, greater than or equal to 8 cm.

Although a single classification hydrocyclone 1604 is depicted in FIG. 1, a classification arrangement may generally comprise one or more classification hydrocyclones.

In some embodiments, in addition to or as an alternative to a classification hydrocyclone, a classification arrangement may comprise one or more of a non-mechanical sedimentation classifier, e.g., a settling cone; a mechanical sedimentation classifier, e.g., a rake classifier or a spiral classifier; a free-settling classifier; and a hindered-settling classifier, e.g., a hydrosizer.

In the embodiment of FIG. 1, the classification hydrocyclone 1604 may have a cut-off particle size, d₅₀^{c}, of approximately 100 μm, as measured under typical hydrocyclone operating conditions. Generally, a cut-off particle size, d₅₀^{c}, in a range from 15 μm to 200 μm, or from 40 μm to 175 μm, or from 60 μm to 150 μm, or from 75 μm to 125 μm, as measured under typical hydrocyclone operating conditions, may provide an advantageous division of input slurry to from a coarser slurry fraction and a finer slurry fraction for a froth-interaction flotation unit, even with a single classification stage. In other embodiments, a classification hydrocyclone may have any suitable d₅₀^{c}, for example, a d₅₀^{c} in a range from 15 μm to 200 μm, or from 40 μm to 175 μm, or from 60 μm to 150 μm, or from 75 μm to 125 μm, as measured under typical hydrocyclone operating conditions.

In the embodiment of FIG. 1, the fluidized-bed flotation unit 1000 comprises a flotation gas supply arrangement 1300.

The flotation gas supply arrangement 1300 of the embodiment of FIG. 1 is configured to supply flotation gas 1301, 1302, 1303 into the volume of slurry 1001. In other embodiments, a flotation gas supply arrangement may be suitable for or configured to supply flotation gas into a volume of slurry held in a tank.

In the embodiment of FIG. 1, air may be used as the flotation gas 1301, 1302, 1303. In other embodiments, any suitable flotation gas(es), e.g., air, argon, nitrogen, hydrogen, or mixtures thereof, may be used.

The flotation gas supply arrangement 1300 of the embodiment of FIG. 1 is configured to supply flotation gas 1301, 1302, 1303 into the volume of slurry 1001 such that the froth layer 1002 is maintained over the volume of slurry 1001. In other embodiments, a flotation gas supply arrangement may or may not be suitable for or configured to supply flotation gas into a volume of slurry such than a froth layer is maintained over said volume of slurry.

As indicated in FIG. 1 by dashed arrows, the flotation gas supply arrangement 1300 of the embodiment of FIG. 1 may be configured to feed flotation gas 1301 into the volume of slurry 1001 via the flotation gas inlet 1108. In other embodiments, a flotation gas supply arrangement may be configured to supply flotation gas into a tank in any suitable manner(s), for example, by feeding flotation gas into a volume of slurry via a flotation gas inlet.

As indicated in FIG. 1 by dashed arrows, the flotation gas supply arrangement 1300 of the embodiment of FIG. 1 may be configured to supply flotation gas into the volume of slurry 1001 by injecting flotation gas 1302 into primary slurry 1401, which the first slurry feeding arrangement 1400 is configured to feed into the volume of slurry 1001 via the primary slurry-flotation gas mixture inlet 1104 and/or by injecting flotation gas 1303 to flotation liquid 1801 collected via the fine slurry outlet 1110, which the circulation arrangement 1800 is configured to feed back into the tank 1100 via the circulation inlet 1111. In other embodiments, a flotation gas supply arrangement may or may not be configured in such manner.

In the embodiment of FIG. 1, the fluidized-bed flotation unit 1000 comprises a flotation liquid supply arrangement 1500 for supplying flotation liquid 1501, 1502 into the volume of slurry 1001. In other embodiments, a flotation unit may or may not comprise such flotation liquid supply arrangement. For example, in some embodiments, maintaining a top surface of a volume of slurry at a set distance from a launder lip of a launder of a tank may be achieved by controlling the operation of slurry feeding arrangement(s) and slurry outlet(s) of said tank.

As indicated in FIG. 1 by dashed arrows, the flotation liquid supply arrangement 1500 of the embodiment of FIG. 1 may be configured to feed flotation liquid 1501 into the volume of slurry 1001 via the flotation liquid inlet 1109 and/or to supply flotation liquid 1502 into the volume of slurry 1001 by adding flotation liquid 1502 to primary slurry 1401, which the first slurry feeding arrangement 1400 is configured to feed into the volume of slurry 1001. In other embodiments, a flotation liquid supply arrangement may be configured to supply flotation liquid into a tank in any suitable manner(s), for example, by feeding flotation liquid into a volume of slurry via a flotation liquid inlet and/or adding flotation liquid to fine slurry, which a first slurry feeding arrangement is configured to feed into said tank.

The flotation liquid supply arrangement 1500 of the embodiment of FIG. 1 may be specifically configured to supply flotation liquid 1502 into the volume of slurry 1001 by feeding flotation liquid 1502 into the slurry sump 1402. In other embodiments, a flotation liquid supply arrangement may be configured to add flotation liquid to fine slurry, which a first slurry feeding arrangement is configured to feed into a tank, in any suitable manner, for example, by feeding flotation liquid to a slurry sump of said first slurry feeding arrangement.

In the embodiment of FIG. 1, the fluidized-bed flotation unit 1000 comprises a slurry agitation arrangement 1900 for agitating the volume of slurry 1001. In other embodiments, a froth-interaction flotation unit may or may not comprise such slurry agitation arrangement. In embodiments, wherein a fluidized-bed flotation unit comprises a slurry agitation arrangement, said slurry agitation arrangement may be implemented in any suitable manner.

The slurry agitation arrangement 1900 of the embodiment of FIG. 1 comprises a rotor 1901 fixed to a drive shaft 1902. As such, the slurry agitation arrangement 1900 is implemented as a mechanical slurry agitation arrangement. In other embodiments, a slurry agitation arrangement of a fluidized-bed flotation unit may or may not comprise such rotor and such drive shaft.

The rotor 1901 of the embodiment of FIG. 1 is arranged at a lower section of the tank 1100. Generally, arranging a rotor of a slurry agitation arrangement at a lower section of a tank may facilitate subjecting settled particles of sediment formed in a tank to further flotation in said tank. In other embodiments, a rotor of a slurry agitation arrangement may be arranged in a tank in any suitable manner, for example, at a lower section of said tank.

In embodiments, wherein a slurry agitation arrangement comprises a rotor and a drive shaft, said slurry agitation arrangement may further comprise a stator such that said rotor and said stator form a rotor-stator mechanism and/or a standpipe surrounding said drive shaft such that a flotation gas supply arrangement may be configured to supply flotation gas into a volume of slurry held in a tank through said standpipe.

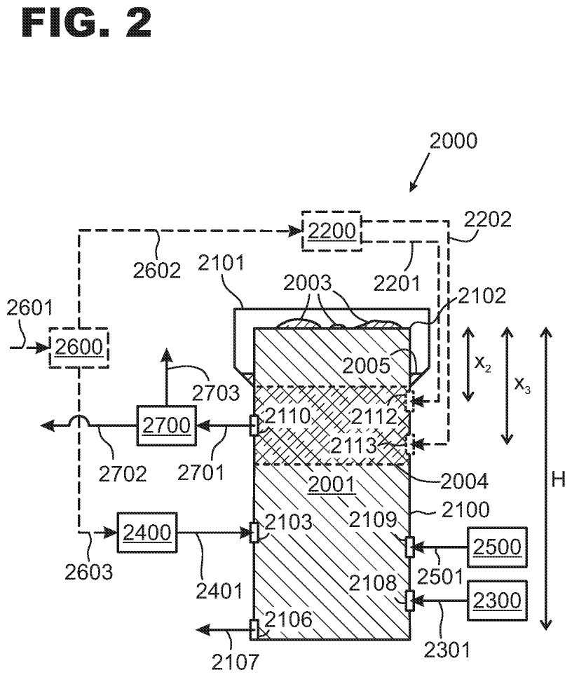

FIG. 2 depicts a fluidized-bed flotation unit 2000 according to an embodiment. Although not explicitly shown in FIG. 2, the fluidized-bed flotation unit 2000, any part thereof, and/or any arrangement of the fluidized-bed flotation unit 2000 may generally comprise any feature(s) and/or element(s) of the embodiment of FIG. 1 or any other embodiments disclosed with reference to, in conjunction with, and/or concomitantly with FIG. 1.

The fluidized-bed flotation unit 2000 of the embodiment of FIG. 2 comprises a tank 2100 for holding a volume of slurry 2001.

The tank 2100 of the embodiment of FIG. 2 comprises a launder 2101 with a launder lip 2102, a fine slurry outlet 2110 below the launder lip 2102, and a coarse slurry outlet 2106 below the fine slurry outlet 2110 at a lower section of the tank 2100 for collecting coarse output slurry 2107 from the volume of slurry 2001, as well as a primary slurry inlet 2103, a flotation gas inlet 2108, and a flotation liquid inlet 2109 at a lower section of the tank 2100.

The fluidized-bed flotation unit 2000 of the embodiment of FIG. 2 comprises a first slurry feeding arrangement 2400 for feeding primary slurry 2401 into the volume of slurry 2001 via the primary slurry inlet 2103, a flotation gas supply arrangement 2300 for supplying flotation gas 2301 into the volume of slurry 2001 via the flotation gas inlet 2108 and a flotation liquid supply arrangement 2500 for supplying flotation liquid 2501 into the volume of slurry 2001 via the flotation liquid inlet 2109.

The fluidized-bed flotation unit 2000 of the embodiment of FIG. 2 also comprises a solid-liquid separation arrangement 2700 configured to collect output slurry 2701 from the volume of slurry 2001 via the fine slurry outlet 2110 and to separate suspended solids and flotation liquid from the output slurry 2701 to form a solids portion 2702 and a liquid portion 2703.

The solid-liquid separation arrangement 2700 of the embodiment of FIG. 2 is configured to guide the solids portion 2702 out of the fluidized-bed flotation unit 2000. The solids portion 2702 may be directed, for example, to further flotation at a distance from the fluidized-bed flotation unit 2000.

As indicated by dashed arrows in FIG. 2, the fluidized-bed flotation unit 2000 of the embodiment of FIG. 2 may further comprise a second slurry feeding arrangement 2200 for feeding secondary slurry 2201 into the tank 2100. In other embodiments, a fluidized-bed flotation unit may or may not comprise such second slurry feeding arrangement. In some embodiments, a fluidized-bed flotation unit may comprise a first slurry feeding arrangement and/or a second slurry feeding arrangement. In such embodiments, any suitable type of slurry, for example, slurry of a broader particle size distribution, may be fed to such first slurry feeding arrangement and/or to such second slurry feeding arrangement.

As also indicated by dashed arrows in FIG. 2, the tank 2100 of the embodiment of FIG. 2 may further comprise a secondary slurry inlet 2112 above the fine slurry outlet 2110 and/or a tertiary slurry inlet 2113 below the fine slurry outlet 2110, and the second slurry feeding arrangement 2200 may be configured to feed secondary slurry 2201 into the tank 2100 via the secondary slurry inlet 2112 and/or via the tertiary slurry inlet 2113. As such, the solid-liquid separation arrangement 2700 may or may not constitute an example of a solid-liquid separation arrangement for feeding secondary slurry into the tank above a fine slurry outlet. In other embodiments, a second slurry feeding arrangement may be configured to feed coarse slurry into a tank in any suitable manner, for example, to a froth layer formed in a tank over a volume of slurry, and/or via a secondary slurry inlet arranged above a fine slurry outlet, and/or via a tertiary slurry inlet arranged at the height of a fine slurry outlet or immediately below said fine slurry outlet.

In some embodiments, at least one inlet of a secondary slurry inlet and a tertiary slurry inlet may be implemented as a slurry-flotation gas mixture inlet, and a flotation gas supply arrangement may be configured to supply flotation gas into a tank by injecting flotation gas into secondary slurry, which a second slurry feeding arrangement is configured to feed into said tank via said at least one inlet.

Additionally or alternatively, in some embodiments, a flotation liquid supply arrangement may be configured to supply flotation liquid into a tank by adding flotation liquid to secondary slurry, which a second slurry feeding arrangement is configured to feed into said tank via a secondary slurry inlet and/or a tertiary slurry inlet.

The tank 2100 of the embodiment of FIG. 2 has a height, H, and each of a vertical distance, x₂, between the secondary slurry inlet 2112 and the launder lip 2102 and a vertical distance, x₃, between the tertiary slurry inlet 2113 and the launder lip 2102 may be less than or equal to 0.4 times the height, H, of the tank 2100. As such, the fluidized-bed flotation unit may be configured to feed secondary slurry 2201, 2202 into the tank 2100 within an upper 40% of the height, H, of the tank 2100. In other embodiments, a fluidized-bed flotation unit may or may not be configured in such manner.

As further indicated by dashed arrows in FIG. 2, the fluidized-bed flotation unit 2000 of the embodiment of FIG. 2 may comprise a classification arrangement 2600 configured to classify input slurry 2601 to form a coarser slurry fraction 2602 and a finer slurry fraction 2603, to feed the coarser slurry fraction 2602 to the second slurry feeding arrangement 2200, and to feed the finer slurry fraction 2603 to the first slurry feeding arrangement 2400. In other embodiments, a fluidized-bed flotation unit may or may not comprise such classification arrangement.

As shown in FIG. 2, the fluidized-bed flotation unit 2000 differs from the fluidized-bed flotation unit 1000 of the embodiment of FIG. 1, at least, in that the fluidized-bed flotation unit 2000 is configured to operate in the absence of a bottom cone in the tank 2100 and in that the volume of slurry 2001 extends to the launder lip 2102, i.e., the fluidized-bed flotation unit 2000 is configured to maintain a froth depth, d^{f}, of substantially zero, e.g., less than 2 cm, or less than 1 cm, or less than 0.5 cm. As is obvious to the skilled person, despite a d^{f} of substantially zero is maintained in the tank 2100, some froth 2003 may still form on the volume of slurry 2001 above the launder lip 2102. Consequently, the fluidized-bed flotation unit 2000 is implemented as an overflow flotation unit. The launder 2101 is configured to collect slurry 2005 from the volume of slurry 2001 by let-ting said slurry 2005 flow over the launder lip 2102.

Herein, “overflow flotation” may refer to flotation, wherein slurry from a volume of slurry held in a tank and, optionally, froth in addition to such slurry, is collected into a launder of said tank over a launder lip of said launder. Additionally or alternatively, overflow flotation may refer to flotation, wherein a d^{f} of substantially zero is maintained in a tank. Consequently, an “overflow flotation unit” may then refer to a unit configured to or suitable for separation of material by overflow flotation.

Although not explicitly shown in FIG. 2, a flotation product collected into a launder of an overflow flotation unit may generally comprise slurry or a mixture of slurry and flotation gas bubbles, which may or may not form froth.

It is to be understood that the embodiments of the first aspect described above may be used in any combination with each other. Several of the embodiments may be combined together to form a further embodiment.

Above, mainly structural aspects of fluidized-bed flotation units are discussed. In the following, more emphasis will lie on aspects related to mineral processing apparatus. What is said above about the ways of implementation, definitions, details, and advantages related to fluidized-bed flotation units apply, mutatis mutandis, to the mineral processing apparatus discussed below. The same applies vice versa.

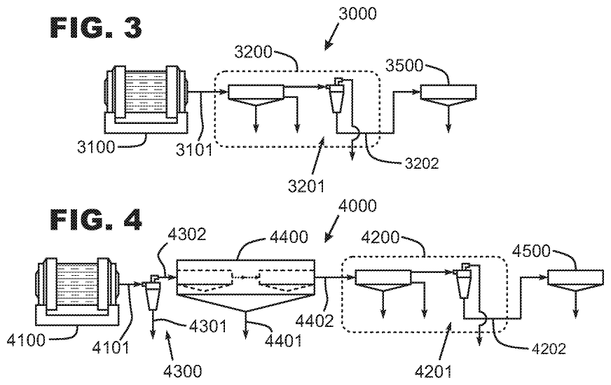

In FIGS. 3 and 4, tanks of flotation units are represented using standard symbols, each comprising a rectangle over an isosceles triangle, wherein each input slurry stream is represented as an arrow extending to a rectangle, each overflow collected into a launder of a tanks is represented by an arrow extending from an apex of a triangle, each coarse output slurry stream collected via a coarse slurry outlet is represented by an arrow extending from a bottom half of a rectangle, and each output slurry stream collected via a fine slurry outlets is represented by an arrow extending from a top half of a rectangle.

FIG. 3 depicts a mineral processing apparatus 3000 according to an embodiment.

The mineral processing apparatus 3000 of the embodiment of FIG. 3 comprises a fluidized-bed flotation unit 3200 with a solid-liquid separation arrangement 3201.

Although not explicitly shown in FIG. 3, the fluidized-bed flotation unit 3200, any part thereof, and/or any arrangement of the fluidized-bed flotation unit 3200 may generally comprise any feature(s) and/or element(s) of the embodiments of any of FIGS. 1-2 or any other embodiments disclosed with reference to, in conjunction with, and/or concomitantly with any of FIGS. 1-2.

The mineral processing apparatus 3000 of the embodiment of FIG. 3 further comprises a comminution unit 3100. In other embodiments, a mineral processing apparatus may or may not comprise a comminution unit.

The comminution unit 3100 of the embodiment of FIG. 1 is configured to grind ore to form ground ore, to mix the ground ore with flotation liquid to form pristine slurry 3101, and to feed the pristine slurry 3101 to the fluidized-bed flotation unit 3200. In embodiments, wherein a mineral processing apparatus comprises a comminution unit, said comminution unit may be configured to operate in any suitable manner.

The mineral processing apparatus 3000 of the embodiment of FIG. 3 further comprises a secondary flotation unit 3500, and the fluidized-bed flotation unit 3200 is configured to pass slurry from a solids portion 3202 formed by the solid-liquid separation arrangement 3201 for further flotation at the secondary flotation unit 3500. In other embodiments, a mineral processing apparatus may or may not comprise a secondary flotation unit such that a fluidized-bed flotation unit of said mineral processing apparatus passes slurry from a solids portion formed by a solid-liquid separation arrangement of said fluidized-bed flotation unit for further flotation at said secondary flotation unit.

In the embodiment of FIG. 3, the fluidized-bed flotation unit 3200 is configured to channel slurry from the solids portion 3202 directly to the secondary flotation unit 3500. In other embodiments, a fluidized-bed flotation unit may or may not be configured to channel slurry from a solids portion directly to a secondary flotation unit. For example, in some embodiments, slurry from a solids portion may be subjected to sizing and/or further comminution prior to being subjected to further flotation at a secondary flotation unit.

FIG. 4 depicts a mineral processing apparatus 4000 according to an embodiment.

The mineral processing apparatus 4000 of the embodiment of FIG. 4 comprises a fluidized-bed flotation unit 4200 with a solid-liquid separation arrangement 4201.

Although not explicitly shown in FIG. 4, the fluidized-bed flotation unit 4200, any part thereof, and/or any arrangement of the fluidized-bed flotation unit 4200 may generally comprise any feature(s) and/or element(s) of the embodiments of any of FIGS. 1-2 or any other embodiments disclosed with reference to, in conjunction with, and/or concomitantly with any of FIGS. 1-2.

The mineral processing apparatus 4000 of the embodiment of FIG. 4 further comprises a comminution unit 4100, a pre-classification unit 4300, and a primary flotation unit 4400. In other embodiments, a mineral processing apparatus may or may not comprise one or more of a comminution unit, a pre-classification unit 4300, and a primary flotation unit 4400.

The comminution unit 4100 of the embodiment of FIG. 4 is configured to grind ore to form ground ore, to mix the ground ore with flotation liquid to form pristine slurry 4101, and to feed the pristine slurry 4101 to the pre-classification unit 4300.

The pre-classification unit 4300 of the embodiment of FIG. 4 is configured to classify the pristine slurry 4101 to form a coarser pristine slurry fraction 4301 and a finer pristine slurry fraction 4302 and to feed the finer pristine slurry fraction 4302 to the primary flotation unit 4400.

The primary flotation unit 4400 of the embodiment of FIG. 4 is configured to separate the finer pristine slurry fraction 4302 to form overflow 4401 and underflow 4402 and to feed the underflow 4402 to the fluidized-bed flotation unit 4200.

As indicated in FIG. 4 using dashed lines, a primary flotation unit may generally comprise one or more tanks. In embodiments, wherein a primary flotation unit comprises a plurality of tanks, individual tanks of said plurality of tanks may be arranged in series.

Herein, individual tanks of a plurality of tanks being “arranged in series” may refer to underflow from one tank being fed to the next until a last individual tank of said plurality of tanks.

The mineral processing apparatus 4000 of the embodiment of FIG. 4 further comprises a secondary flotation unit 4500, and the fluidized-bed flotation unit 4200 is configured to feed a solids portion 4202 formed by the solid-liquid separation arrangement 4201 to the secondary flotation unit 4500.

Above, mainly structural aspects of fluidized-bed flotation units and mineral processing apparatus are discussed. In the following, more emphasis will lie on aspects related to fluidized-bed flotation methods. What is said above about the ways of implementation, definitions, details, and advantages related to fluidized-bed flotation units and mineral processing apparatus apply, mutatis mutandis, to the methods discussed below. The same applies vice versa.

It is specifically to be understood that any fluidized-bed flotation method according to this specification may be used to operate a fluidized-bed flotation unit according to this specification. Correspondingly, any fluidized-bed flotation unit according to this specification may be operated in accordance with a method according to this specification.

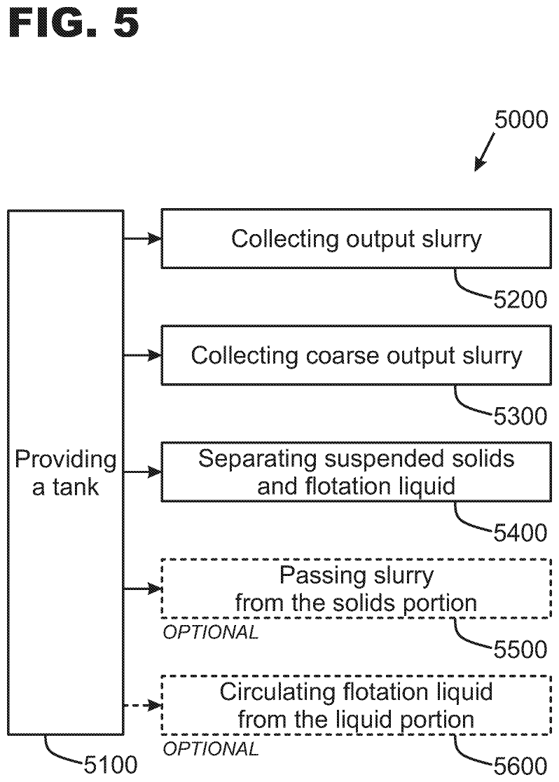

FIG. 5 illustrates a fluidized-bed flotation method 5000 according to an embodiment.

In the embodiment of FIG. 5, the fluidized-bed flotation method 5000 comprises, in process 5100, providing a tank, comprising a launder with a launder lip, for holding a volume of slurry.

Herein, a “process” may refer to a set of operations, leading to an end result. A process may be divisible to a plurality of subprocesses, wherein individual sub-processes of such plurality of sub-processes may or may not share common operations.

Herein, an “operation” may refer to a measure taken in order to achieve an effect. Individual operations of a process may generally be performed at least partly successively or at least partly concurrently with one another.

Throughout this disclosure, “providing” may refer to arranging available the element or part at issue.

In the embodiment of FIG. 5, the fluidized-bed flotation method 5000 comprises, in subprocess 5200, collecting output slurry from the volume of slurry at a first height, h₁, below the launder lip.

In the embodiment of FIG. 5, the fluidized-bed flotation method 5000 comprises, in subprocess 5300, collecting coarse output slurry from the volume of slurry at a second height, h₂, below the first height, h₁.

In the embodiment of FIG. 5, the fluidized-bed flotation method 5000 comprises, in subprocess 5400, separating suspended solids and flotation liquid from the output slurry to form a solids portion and a liquid portion.

As indicated in FIG. 5 using dashed lines, the fluidized-bed flotation method 5000 may comprise, in subprocess 5500, passing slurry from the solids portion for further flotation at a distance from the tank. In other embodiments, a fluidized-bed flotation method may or may not comprise passing slurry from the solids portion in such manner.

As indicated in FIG. 5 using dashed lines, the fluidized-bed flotation method 5000 of the embodiment of FIG. 5 may further comprise, in subprocess 5600, circulating flotation liquid from the liquid portion back into the tank. In other embodiments, a fluidized-bed flotation method may or may not comprise circulating flotation liquid from the liquid portion in such manner.

Generally, a fluidized-bed flotation method may comprise any process(es), operation(s), and/or feature(s) not disclosed herein in relation to the fluidized-bed flotation method 5000 of the embodiment of FIG. 5.

For example, in some embodiments, a solids portion may have a solids fraction, ϕ^{sp}, greater than or equal to 0.2, or greater than or equal to 0.3 or greater than or equal to 0.4.

In some embodiments, a liquid portion may have a solids fraction, ϕ^{lp}, less than or equal to 0.1, or less than or equal to 0.05, or less than or equal to 0.02, or less than or equal to 0.01.

In some embodiments, a fluidized-bed flotation method may comprise collecting a flotation product from a tank into a launder of said tank, for example, over a launder lip of said launder.

It is obvious to a person skilled in the art that with the advancement of technology, the basic idea of the invention may be implemented in various ways. The invention and its embodiments are thus not limited to the examples described above, instead they may vary within the scope of the claims.

It will be understood that any benefits and advantages described above may relate to one embodiment or may relate to several embodiments. The embodiments are not limited to those that solve any or all of the stated problems or those that have any or all of the stated benefits and advantages.

The term “comprising” is used in this specification to mean including the feature(s) or act(s) followed there-after, without excluding the presence of one or more additional features or acts. It will further be understood that reference to ‘an’ item refers to one or more of those items.

REFERENCE SIGNS

| d₅₀^{c} | cut-off particle size of classification hydrocyclone |
|---|---|
| d₅₀^{sl} | cut-off particle size of solid-liquid separation hydrocyclone |
| ϕ^{cs} | solids fraction of the coarser slurry fraction |
| ϕ^{fs} | solids fraction of the finer slurry fraction |
| ϕ^{sp} | solids fraction of the solids portion |
| ϕ^{os} | solids fraction of the output slurry |
| ϕ^{lp} | solids fraction of the liquid portion |
| d^{f} | froth depth of the froth layer |
| dₒ^{cs} | opening diameter of the coarse slurry outlet |
| H | height of the tank |
| x₂ | vertical distance between the secondary slurry inlet and the |
| | launder lip |
| x₃ | vertical distance between the tertiary slurry inlet and the |
| | launder lip |
| h₁ | first height |
| h₂ | second height |
| 1000 | fluidized-bed flotation unit |
| 1001 | volume of slurry |
| 1002 | froth layer |
| 1003 | froth |
| 1004 | fluidized bed |
| 1100 | tank |
| 1101 | launder |
| 1102 | launder lip |
| 1103 | primary slurry inlet |
| 1104 | primary slurry-flotation gas mixture inlet |
| 1105 | bottom cone |
| 1106 | coarse slurry outlet |
| 1107 | coarse output slurry |
| 1108 | flotation gas inlet |
| 1109 | flotation liquid inlet |
| 1110 | fine slurry outlet |
| 1111 | circulation inlet |
| 1200 | second slurry feeding arrangement |
| 1201 | secondary slurry |
| 1300 | flotation gas supply arrangement |
| 1301 | flotation gas |
| 1302 | flotation gas |
| 1303 | flotation gas |
| 1400 | first slurry feeding arrangement |
| 1401 | primary slurry |
| 1402 | slurry sump |
| 1403 | sump slurry outlet |
| 1500 | flotation liquid supply arrangement |
| 1501 | flotation liquid |
| 1502 | flotation liquid |
| 1600 | classification arrangement |
| 1601 | input slurry |
| 1602 | coarser slurry fraction |
| 1603 | finer slurry fraction |
| 1604 | classification hydrocyclone |
| 1700 | solid-liquid separation arrangement |
| 1701 | output slurry |
| 1702 | solids portion |
| 1703 | liquid portion |
| 1704 | solid-liquid separation hydrocyclone |
| 1800 | circulation arrangement |
| 1801 | flotation liquid |
| 1802 | flotation liquid |
| 1900 | slurry agitation arrangement |
| 1901 | rotor |
| 1902 | drive shaft |
| 2000 | fluidized-bed flotation unit |
| 2001 | volume of slurry |
| 2003 | froth |
| 2004 | fluidized bed |
| 2005 | slurry |
| 2100 | tank |
| 2101 | launder |
| 2102 | launder lip |
| 2103 | primary slurry inlet |
| 2106 | coarse slurry outlet |
| 2107 | coarse output slurry |
| 2108 | flotation gas inlet |
| 2109 | flotation liquid inlet |
| 2110 | fine slurry outlet |
| 2112 | secondary slurry inlet |
| 2113 | tertiary slurry inlet |
| 2200 | second slurry feeding |
| 2201 | secondary slurry |
| 2202 | secondary slurry |
| 2300 | flotation gas supply arrangement |
| 2301 | flotation gas |
| 2400 | first slurry feeding arrangement |
| 2401 | primary slurry |
| 2500 | flotation liquid supply arrangement |
| 2501 | flotation liquid |
| 2600 | classification arrangement |
| 2601 | input slurry |
| 2602 | coarser slurry fraction |
| 2603 | finer slurry fraction |
| 2700 | solid-liquid separation arrangement |
| 2701 | output slurry |
| 2702 | solids portion |
| 2703 | liquid portion |
| 3000 | mineral processing apparatus |
| 3100 | comminution unit |
| 3101 | pristine slurry |
| 3200 | fluidized-bed flotation unit |
| 3201 | solid-liquid separation arrangement |
| 3202 | solids portion |
| 3500 | secondary flotation unit |
| 4000 | mineral processing apparatus |
| 4100 | comminution unit |
| 4101 | pristine slurry |
| 4200 | fluidized-bed flotation unit |
| 4201 | solid-liquid separation arrangement |
| 4202 | solids portion |
| 4300 | pre-classification unit |
| 4301 | coarser pristine slurry fraction |
| 4302 | finer pristine slurry fraction |
| 4400 | primary flotation unit |
| 4401 | overflow |
| 4402 | underflow |
| 4500 | secondary flotation unit |
| 5000 | fluidized-bed flotation method |
| 5100 | providing a tank |
| 5200 | collecting output slurry |
| 5300 | collecting coarse output slurry |
| 5400 | separating suspended solids and flotation liquid |
| 5500 | passing slurry from the solids portion |
| 5600 | circulating flotation liquid from the liquid portion |

1. A fluidized-bed flotation unit, comprising a tank for holding a volume of slurry, the tank comprising a launder with a launder lip, a fine slurry outlet below the launder lip, and a coarse slurry outlet below the fine slurry outlet for discharging coarse output slurry from the volume of slurry,
wherein the fluidized-bed flotation unit comprises a solid-liquid separation arrangement configured to collect output slurry from the volume of slurry via the fine slurry outlet and to separate suspended solids and flotation liquid from the output slurry to form a solids portion and a liquid portion.

2. The fluidized-bed flotation unit according to claim 1,
wherein the solid-liquid separation arrangement is configured to guide the solids portion out of the fluidized-bed flotation unit.

3. (canceled)

4. (canceled)

5. (canceled)

6. The fluidized-bed flotation unit according to claim 1, wherein the fluidized-bed flotation unit comprises a circulation arrangement for circulating flotation liquid from the liquid portion back into the tank.

7. (canceled)

8. The fluidized-bed flotation unit according to claim 6, wherein the tank comprises a circulation inlet and the circulation arrangement is configured to feed flotation liquid from the liquid portion back into the tank via the circulation inlet.

9. The fluidized-bed flotation unit according to claim 8, wherein the fluidized-bed flotation unit comprises a flotation gas supply arrangement configured to supply flotation gas into the volume of slurry by injecting flotation gas to flotation liquid, which the circulation arrangement is configured to feed back into the tank via the circulation inlet.

10. The fluidized-bed flotation unit according to claim 6, wherein the fluidized-bed flotation unit comprises a first slurry feeding arrangement for feeding primary slurry into the volume of slurry, and the circulation arrangement is configured to circulate flotation liquid from the liquid portion back into the tank by adding such flotation liquid to primary slurry, which the first slurry feeding arrangement is configured to feed into the volume of slurry.

11. The fluidized-bed flotation unit according to claim 1, wherein the fluidized-bed flotation unit comprises a second slurry feeding arrangement for feeding secondary slurry into the tank.

12. The fluidized-bed flotation unit according to claim 11, wherein the tank has a height, H, and the fluidized-bed flotation unit is configured to feed secondary slurry into the tank within an upper 40% of the height, H, of the tank.

13. The fluidized-bed flotation unit according to claim 11, wherein the second slurry feeding arrangement is configured to feed secondary slurry into the tank above the fine slurry outlet.

14. The fluidized-bed flotation unit according to claim 13, wherein the second slurry feeding arrangement is configured to feed secondary slurry to a froth layer formed in the tank over the volume of slurry.

15. The fluidized-bed flotation unit according to claim 13, wherein the tank comprises a secondary slurry inlet above the fine slurry outlet, and the second slurry feeding arrangement is configured to feed secondary slurry into the tank via the secondary slurry inlet.

16. The fluidized-bed flotation unit according to claim 11, wherein the tank comprises a tertiary slurry inlet arranged at the height of the fine slurry outlet or immediately below the fine slurry outlet, and the second slurry feeding arrangement is configured to feed secondary slurry into the tank via the tertiary slurry inlet.

17. The fluidized-bed flotation unit according to claim 11, wherein the fluidized-bed flotation unit comprises a classification arrangement configured to classify input slurry to form a coarser slurry fraction and a finer slurry fraction, to feed the coarser slurry fraction to the second slurry feeding arrangement, and to channel the finer slurry fraction to be fed into the volume of slurry below the fine slurry outlet.

18. The fluidized-bed flotation unit according to claim 1, wherein the fluidized-bed flotation unit comprises a flotation liquid supply arrangement for supplying flotation liquid into the volume of slurry.

19. (canceled)

20. The fluidized-bed flotation unit according to claim 1, wherein the fluidized-bed flotation unit comprises a slurry agitation arrangement for agitating the volume of slurry.

21. Use of fluidized-bed flotation unit according to claim 1 for separation of a valuable material suspended in slurry.

22. (canceled)

23. A mineral processing apparatus, comprising a fluidized-bed flotation unit according to claim 1.

24. The mineral processing apparatus according to claim 23, wherein the mineral processing apparatus comprises a comminution unit configured to grind ore to form ground ore, to mix the ground ore with flotation liquid to form pristine slurry, and to feed the pristine slurry to the fluidized-bed flotation unit.

25. (canceled)

26. (canceled)

27. A fluidized-bed flotation method, comprising:
providing a tank for holding a volume of slurry, the tank comprising a launder with a launder lip;
collecting output slurry from the volume of slurry at a first height, h₁, below the launder lip; and
collecting coarse output slurry from the volume of slurry at a second height, h₂, below the first height, h₁;
wherein the fluidized-bed flotation method comprises separating suspended solids and flotation liquid from the output slurry to form a solids portion and a liquid portion.

28. The fluidized-bed flotation method according to claim 27,
wherein the fluidized-bed flotation method comprises passing slurry from the solids portion for further flotation at a distance from the tank.

29. (canceled)

30. (canceled)

31. (canceled)
